(19) United States
(12) Patent Application Publication
(10) Pub. No.: US 2025/0222528 A1
(43) Pub. Date: Jul. 10, 2025

(54) CUTTING INSERT, CUTTING TOOL, AND METHOD FOR MANUFACTURING MACHINED PRODUCT

(71) Applicant: KYOCERA CORPORATION, Kyoto (JP)

(72) Inventor: Ryosuke IZUTSU, Kyoto (JP)

(21) Appl. No.: 18/724,193

(22) PCT Filed: Dec. 28, 2022
(86) PCT No.: PCT/JP2022/048586

§ 371 Date: Jun. 26, 2024

(30) Foreign Application Priority Data
Jan. 5, 2022 (JP) 2022-000615

(51) Int. Cl. B23B 27/16

(52) U.S. Cl. CPC B23B 27/16; B23B 2222/28; B23B 2222/88

(57) ABSTRACT

There is a demand for a cutting insert capable of machining a workpiece under a wide range of cutting conditions. The cutting insert has a first portion, and a second portion protruding from a front end of the first portion. The second portion has an upper surface, a cutting edge, a rising surface, and a connecting surface having a recessed curved surface shape. The rising surface is located closer to the first portion than the upper surface, and is inclined upward with increasing distance from the upper surface. The connecting surface is located between the upper surface and the rising surface, and is connected to the upper surface and the rising surface. In a cross section having a bisecting line of a first corner, a virtual extended line of the upper surface and a virtual extended line of the rising surface intersect at an acute angle.

### TECHNICAL FIELD

The present disclosure relates to a cutting insert used in the machining of a workpiece, a cutting tool, and a method for manufacturing a machined product. Examples of the machining of the workpiece have turning processing and milling processing, for example. Examples of turning processing have external turning, boring, groove-forming and cutting-off processing, for example.

### BACKGROUND OF INVENTION

A cutting tool used in the machining of a workpiece made of a metal material or the like is discussed in Patent Document 1, for example. The cutting tool described in Patent Document 1 has a cutting insert and a holder. The cutting insert has a rake face, a flank face, a cutting edge, and a wall face. The rake face is inclined downward with increasing distance from the cutting edge, and the wall face is inclined upward with increasing distance from the rake face.

### CITATION LIST

### Patent Literature

Patent Document 1: JP 2008-207292 A

### SUMMARY

A cutting insert according to the present disclosure has a first portion having a rod shape and extending along a central axis from a front end toward a rear end, and a second portion protruding from the front end in a direction orthogonal to the central axis. The second portion has a triangular shape in a front view. The second portion has an upper surface having a first corner protruding from the first portion, a first side extending from the first corner toward the first portion, and a second side extending from the first corner toward the first portion, the second side being located closer to the rear end than the first side. The second portion has a cutting edge located on at least a part of the first corner, the first side, and the second side, a rising surface located closer to the first portion than the upper surface and being inclined upward with increasing distance from the upper surface, an upper end surface located closer to the first portion than the rising surface, and a connecting surface having a recessed curved surface shape, the connecting surface being located between the upper surface and the rising surface, and being connected to the upper surface and the rising surface. In a cross section orthogonal to the upper end surface and having a bisecting line of the first corner, a virtual extended line of the upper surface and a virtual extended line of the rising surface intersect each other at an acute angle.

### BRIEF DESCRIPTION OF THE DRAWINGS

FIG. 1 is a perspective view illustrating a cutting insert according to a non-limiting aspect of the present disclosure.

FIG. 2 is an enlarged view of a region A1 illustrated in FIG. 1.

FIG. 3 is an enlarged view of a region A2 illustrated in FIG. 2.

FIG. 4 is a top view of the cutting insert illustrated in FIG. 1, as viewed from above.

FIG. 5 is an enlarged view of a region A3 illustrated in FIG. 4.

FIG. 6 is an enlarged view of a region A4 illustrated in FIG. 5.

FIG. 7 is a side view of the cutting insert illustrated in FIG. 4, as viewed from a direction B1.

FIG. 8 is a side view of the cutting insert illustrated in FIG. 4, as viewed from a direction B2.

FIG. 9 is an enlarged view of a region A5 illustrated in FIG. 8.

FIG. 10 is an enlarged view of a region A6 illustrated in FIG. 9.

FIG. 11 is a cross-sectional view illustrating an XI-XI cross section illustrated in FIG. 6.

FIG. 12 is a cross-sectional view illustrating an XII-XII cross section illustrated in FIG. 6.

FIG. 13 is a perspective view illustrating a cutting tool according to a non-limiting aspect of the present disclosure.

FIG. 14 is a top view of the cutting tool illustrated in FIG. 13.

FIG. 15 is a schematic view of a step in a method for manufacturing a machined product of a non-limiting aspect of the present disclosure.

FIG. 16 is a schematic view of a step in a method for manufacturing a machined product according to a non-limiting aspect of the present disclosure.

FIG. 17 is a schematic view of a step in the method for manufacturing the machined product according to the non-limiting aspect of the present disclosure.

### DESCRIPTION OF EMBODIMENTS

A detailed description will be given below, with reference to the drawings, of a cutting insert 1 according to a non-limiting example of the present disclosure (hereinafter, simply referred to as “insert 1”). However, for convenience, each of the figures referred to below is a simplified representation of only the main members necessary for the description of the non-limiting embodiments. Thus, the insert 1 may have any constituent member not illustrated in each of the drawings referred to. The dimensions of members in the respective drawings do not accurately represent the actual dimensions of constituent members, the dimensional ratio of respective members, and the like.

### Cutting Insert

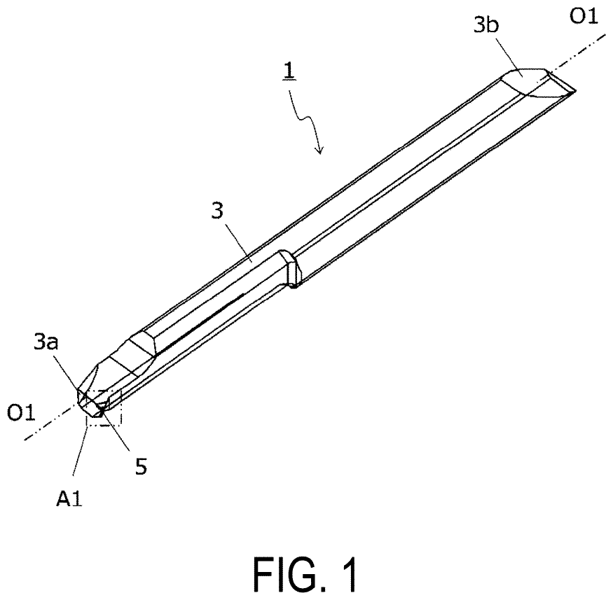

The insert 1 is substantially rod-shaped overall, as in a non-limiting example illustrated in FIG. 1, and has a first portion 3 and a second portion 5. The first portion 3 is rod-shaped and extends from a front end 3a toward a rear end 3b along a central axis O1, and is a portion serving as a base of the insert 1. The first portion 3 in the non-limiting example illustrated in FIG. 1 has a substantially circular pillar shape. By attaching the first portion 3 to a holder to be described later, the insert 1 is fixed to the holder.

In the present disclosure, the term “central axis O1” is an axis along the longitudinal direction of the first portion 3, and is an axis passing through the center of the front end 3a side and/or the rear end 3b side of the first portion 3. For example, an axis passing through the center of gravity of the first portion 3 when viewed from the rear end 3b side and extending along the longitudinal direction may be regarded as the central axis O1.

The size of the first portion 3 is not limited to a specific value. The length of the first portion 3 in the direction along the central axis O1 can be set in a range from 30 mm to 80 mm, for example. A maximum value of the width of the first portion 3 in a direction orthogonal to the central axis O1 can be set in a range from 3 mm to 10 mm, for example.

The second portion 5 protrudes in a direction orthogonal to the central axis O1 from a portion of the first portion 3 on the front end 3a side. At this time, the second portion 5 need not necessarily protrude from the portion having the front end 3a of the first portion 3, but in the non-limiting example illustrated in FIG. 1, the second portion 5 protrudes from the portion having the front end 3a of the first portion 3, in the direction orthogonal to the central axis O1.

The second portion 5 has a cutting edge 7 as will be described later, and plays a main role when machining the workpiece. Therefore, the first portion 3 and the second portion 5 of the insert 1 may be referred to as a base portion and a cutting portion, respectively. The first portion 3 and the second portion 5 may be separate members, or may be integrally formed. In the non-limiting example illustrated in FIG. 1, the first portion 3 and the second portion 5 are integrally formed.

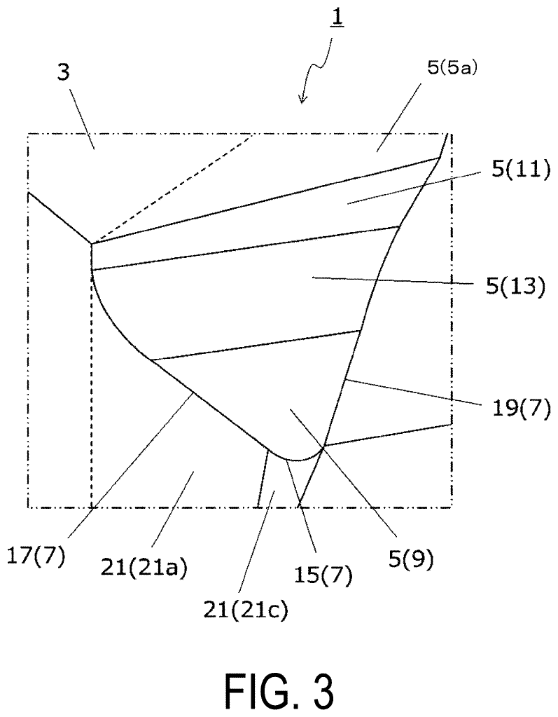

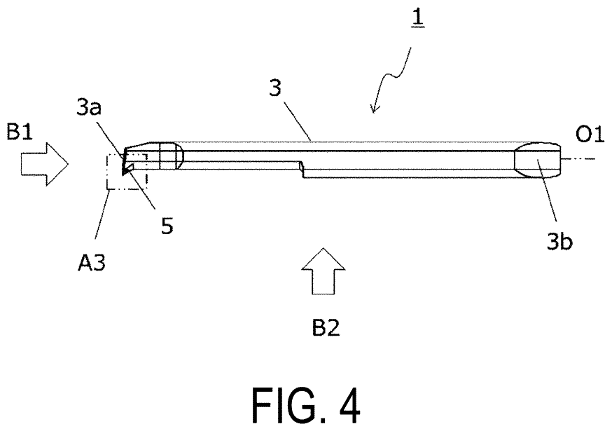

The second portion 5 has an upper surface 9, the cutting edge 7, a rising surface 11, an upper end surface 5a, and a connecting surface 13. The upper surface 9 has a triangular shape having a first corner 15, a first side 17 and a second side 19. The first corner 15 of the upper surface 9 protrudes in a direction orthogonal to the central axis O1. Thus, the first corner 15 is most distant from the first portion 3 on the upper surface 9. Note that the first corner 15 need not necessarily be a corner in a strict sense. The first corner 15 in a non-limiting example illustrated in FIG. 3 has a protruding curved shape protruding in a direction away from the first portion 3. The first corner 15 may have an arc shape.

The first side 17 and the second side 19 each extend from the first corner 15. The first side 17 and the second side 19 each extend from the first corner 15 toward the first portion 3. The interval between the first side 17 and the second side 19 increases with increasing distance from the first corner 15. In the non-limiting example illustrated in FIG. 3, the first side 17 is located on the side of the front end 3a, and the second side 19 is located on the side of the rear end 3b. In other words, the second side 19 is located closer to the rear end 3b than the first side 17. The first side 17 and the second side 19 may each have a linear shape.

The size of the upper surface 9 is not limited to a specific value. In a front view, the width of the upper surface 9 in the direction along the central axis O1 can be set in a range from 0.1 mm to 3 mm, for example. In a front view, the width of the upper surface 9 in a direction orthogonal to the central axis O1 can be set in a range from 0.08 mm to 2 mm, for example. In the present disclosure, a front view of the upper surface 9 may be referred to as a top view.

The first side 17, the second side 19, and the first corner 15 of the upper surface 9 are separated from the first portion 3 and constitute an outer edge of the insert 1 in a top view. The cutting edge 7 is located on at least a part of the first side 17, the second side 19, and the first corner 15. Machining of the workpiece can be performed by bringing the cutting edge 7 into contact with the workpiece.

The rising surface 11 is a surface located closer to the first portion 3 than the upper surface 9, and is inclined with respect to the upper surface 9. Specifically, the rising surface 11 is inclined upward with increasing distance from the upper surface 9. The rising surface 11 is a surface located forward in a travel direction of chips generated by the cutting edge 7, and the chips can come into contact with the rising surface 11. By bringing the chips into contact with the rising surface 11, the chips can be controlled by reducing a flow speed of the chips, changing the flow direction of the chips, or deforming the chips.

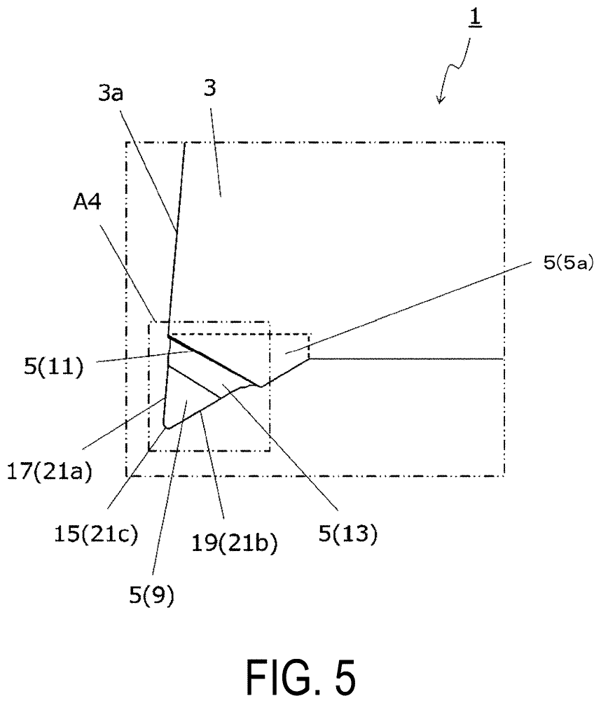

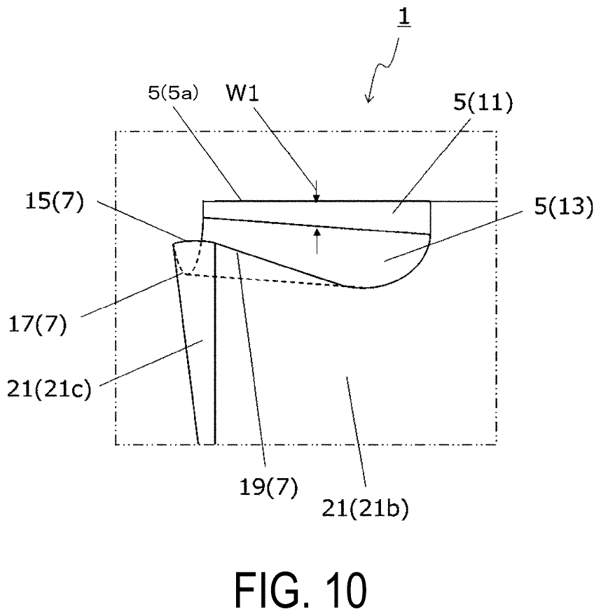

The upper end surface 5a is a surface located closer to the first portion 3 than the rising surface 11, and is a surface located uppermost in the second portion 5. The upper end surface 5a in a non-limiting example illustrated in FIG. 5 is flat. The upper end surface 5a in a non-limiting example illustrated in FIG. 10 is parallel to the central axis O1. In a case where the upper end surface 5a is parallel to the central axis O1, the upper end surface 5a may be used as a reference plane for position adjustment of the cutting edge 7 in the vertical direction.

The upper surface 9 in the non-limiting example illustrated in FIG. 10 is slightly inclined with respect to the upper end surface 5a. Specifically, in a case where the upper end surface 5a is used as the reference plane, the upper surface 9 is slightly inclined downward with increasing proximity to the rear end 3b.

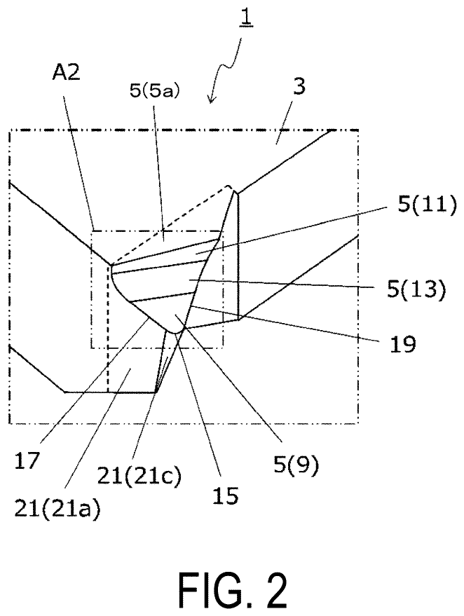

The connecting surface 13 is located between the upper surface 9 and the rising surface 11, and is connected to the upper surface 9 and the rising surface 11. In a non-limiting example illustrated in FIG. 2, the upper surface 9 and the rising surface 11 are flat, while the connecting surface 13 has a recessed curved surface shape. Specifically, in a cross section (hereinafter also referred to as a first cross section) orthogonal to the upper end surface 5a and having a bisecting line of the first corner 15, the upper surface 9 and the rising surface 11 are represented by straight lines, while the connecting surface 13 is represented by a recessed curved line. A surface formed by the upper surface 9, the rising surface 11, and the connecting surface 13 in the second portion 5 has a recessed shape on the whole.

For example, in a case where the first corner 15 has a protruding curved shape or an arc shape, the bisecting line of the first corner 15 may be replaced with a bisecting line of an angle formed by tangents at both ends of the first corner 15. For example, in a case where the first corner 15 is connected to the first side 17 and the second side 19, and the first side 17 and the second side 19 have a linear shape, an angle formed by virtual extended lines obtained by extending the first side 17 and the second side 19 may be replaced with the bisecting line of the first corner 15. The cross section having the bisecting line of the first corner 15 is a cross section having the entire bisecting line of the first corner 15. In the cutting tool according to the present disclosure, for convenience of description, a part of the above-described first cross section is enlarged and illustrated in the drawings.

In the non-limiting example illustrated in FIG. 10, the upper surface 9 is slightly inclined with respect to the upper end surface 5a. Thus, the first cross section is orthogonal to the upper end surface 5a and is inclined with respect to the upper surface 9. “Inclined” here is intended to mean neither orthogonal nor parallel. The first cross section may be orthogonal to the rising surface 11 while being inclined with respect to the upper surface 9.

In a case where the insert 1 does not have the connecting surface 13 and the upper surface 9 and the rising surface 11 are connected to each other, there is a concern that chips may become clogged in the vicinity of the boundary between the upper surface 9 and the rising surface 11. However, since the connecting surface 13 having the recessed curved surface shape is located between the upper surface 9 and the rising surface 11, the chip clogging is less likely to occur.

The second portion 5 may have a side surface 21. The side surface 21 is connected to the first corner 15, the first side 17, and the second side 19 of the upper surface 9. Thus, the cutting edge 7 may be said to be located at an intersection of the upper surface 9 and the side surface 21. The side surface 21 located along the cutting edge 7 may function as a so-called flank face. In a case in which the side surface 21 functions as the flank face, the upper surface 9 may function as a so-called rake face.

The side surface 21 may have a first side surface 21a, a second side surface 21b, and a corner side surface 21c. The first side surface 21a is connected to the first side 17. The second side surface 21b is connected to the second side 19. The corner side surface 21c is connected to the first corner 15. The first side surface 21a connected to the first side 17 and the second side surface 21b connected to the second side 19 may each be flat surfaces. In a case where the side surface 21 functions as the flank face, the first side surface 21a and the second side surface 21b may approach each other with increasing distance from the upper surface 9. In a case where the first corner 15 has the protruding curved shape as described above, the corner side surface 21c connected to the first corner 15 may have a protruding curved surface shape.

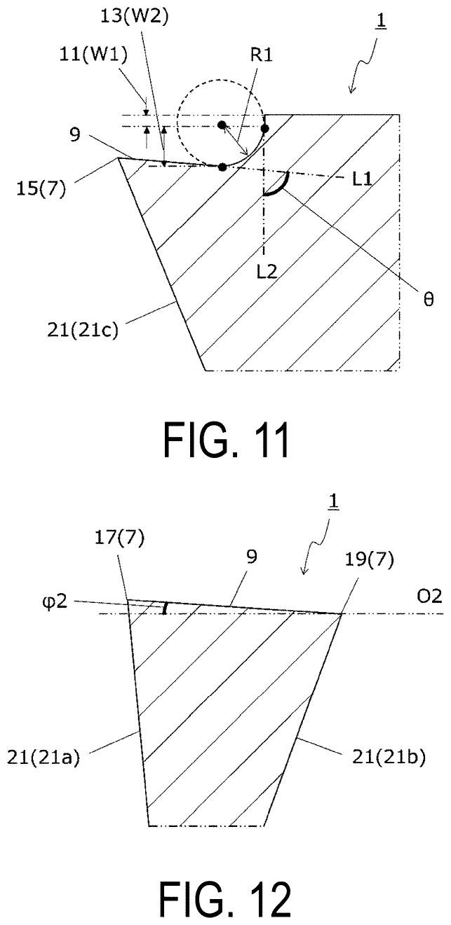

As in a non-limiting example illustrated in FIG. 11, in the first cross section, a virtual extended line L1 of the upper surface 9 and a virtual extended line L2 of the rising surface 11 may intersect at an acute angle. In a case where the virtual extended lines L1 and L2 intersect each other at an obtuse angle, depending on the machining conditions, it is difficult to sufficiently reduce the flow speed of the chips on the rising surface 11. Thus, there is a concern that control of the chips may become difficult as a result of the chips passing over the rising surface 11.

However, in a case where the virtual extended lines L1 and L2 intersect each other at an acute angle, the flow speed of the chips can be sufficiently reduced, and the chips curl more easily. When the chips travel along the upper surface 9, the chips travel more easily in parallel to the upper surface 9. When the chips travel along the rising surface 11, the chips travel more easily parallel to the rising surface 11. Here, the travel direction of the chips when traveling along the rising surface 11 has a component that is reversed with respect to the travel direction of the chips when traveling along the upper surface 9. Therefore, the chips curl more easily, as described above.

An angle θ at which the virtual extended lines L1 and L2 intersect each other in the first cross section is not limited to a specific value as long as it is an acute angle. The angle θ may be set to be approximately in a range from 75° to 89.8°, for example. In a case where the angle θ is 75° or more, the chips are less likely to become clogged on the connecting surface 13. In a case where the angle θ is 89.8° or less, the chips are stable and curl easily.

In a case where the entire upper surface 9 and the entire rising surface 11 are not flat, respectively, the virtual extended lines L1 and L2 may be evaluated by the following procedure. First, in the first cross section, a tangent in contact with the upper surface 9 and the connecting surface 13 at the boundary between the upper surface 9 and the connecting surface 13 is specified. This tangent may be used as the virtual extended line L1. In the first cross section, a tangent in contact with the rising surface 11 and the connecting surface 13 at the boundary between the rising surface 11 and the connecting surface 13 is specified. This tangent may be used as the virtual extended line L2.

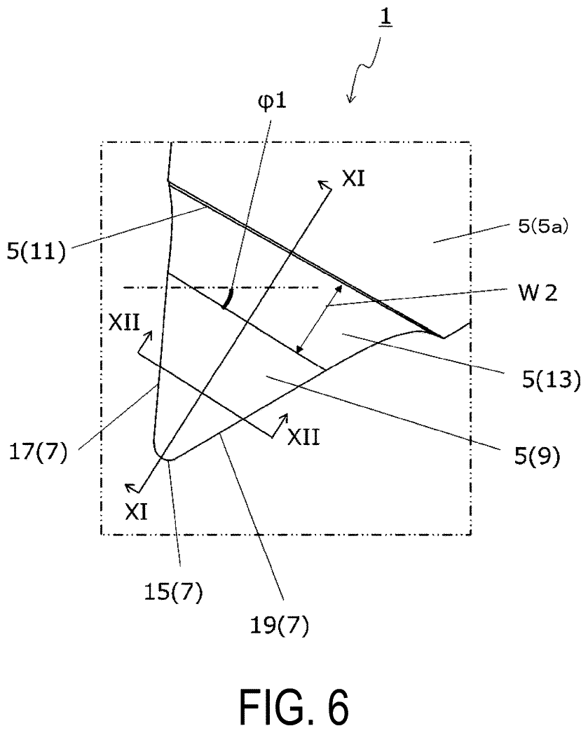

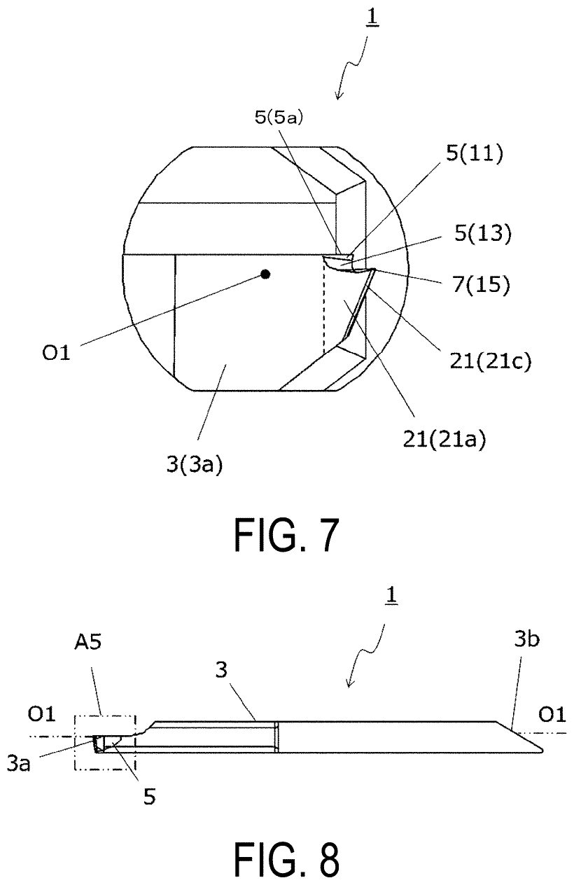

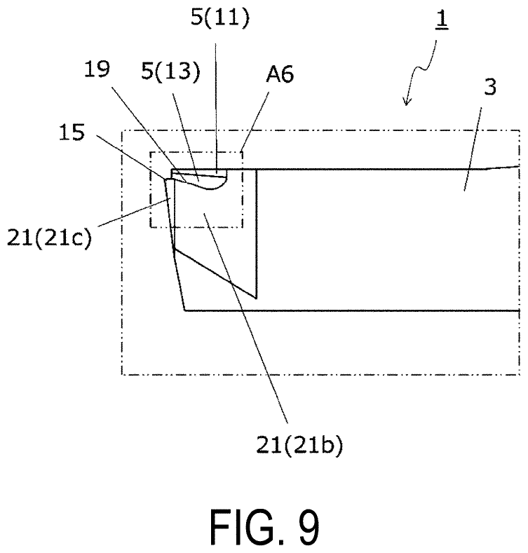

The connecting surface 13 in a non-limiting example illustrated in FIG. 6 has a groove shape extending in a direction inclined with respect to the central axis O1. At this time, the groove-shaped connecting surface 13 may be inclined so as to separate from the central axis O1 with increasing proximity to the rear end 3b.

An inclination angle φ1 with respect to the central axis O1 in the extending direction of the connecting surface 13 in a top view is not limited to a specific value, and may be in a range of 0°<θ<90°. Particularly, in a case where the inclination angle φ1 is in a range of 0°<θ<45°, chip dischargeability is excellent. When the direction in which the chips flow in contact with the connecting surface 13 changes, the chips tend to flow in the direction orthogonal to the central axis O1 when the inclination angle φ1 is larger than 45°, and the chips tend to flow toward the rear end 3b when the inclination angle φ1 is smaller than 45°.

In general, a portion of the cutting edge 7 located on the first side 17 is referred to as a main cutting edge, and the main cutting edge is often used as the main blade in the machining. This is because the chips generated by the main cutting edge 7 located on the first side 17 easily travel toward the rear end 3b, and chip dischargeability is excellent. In a case where the groove-shaped connecting surface 13 is inclined as described above, the chips traveling toward the rear end 3b are more likely to come into contact with the connecting surface 13. Thus, the flow of the chips is easily controlled on the connecting surface 13.

From the viewpoint of enhancing the chip dischargeability, the rising surface 11 may be inclined with respect to the central axis O1 so as to separate from the central axis O1 with increasing proximity to the rear end 3b in a top view. In this case, the chips traveling toward the rear end 3b are more likely to come into contact with the rising surface 11. Thus, the flow of chips is easily controlled on the rising surface 11.

The upper surface 9 may be parallel to the central axis O1 or may be inclined with respect to the central axis O1. For example, as in a non-limiting example illustrated in FIG. 12, the upper surface 9 may be inclined downward with increasing proximity to the rear end 3b. In FIG. 12, in order to facilitate visual understanding of an inclination angle φ2, a virtual straight line O2 parallel to the central axis O1 is set, and the inclination angle φ2 is indicated by an angle formed between the virtual straight line O2 and the upper surface 9. In a case where the upper surface 9 is inclined as described above, the chips are more likely to travel toward the rear end 3b, and chip dischargeability is excellent.

In a case where the connecting surface 13 has the groove shape, the connecting surface 13 may be open to the second side surface 21b. The chips whose flow is controlled on the connecting surface 13 are likely to stably travel toward the rear end 3b, and the insert 1 is likely to have excellent chip dischargeability. The connecting surface 13 may be open to the first side surface 21a.

Depending on the structure of the workpiece, there may be a requirement to discharge the chips toward the front end 3a. In a case where the connecting surface 13 is open to the first side surface 21a, chip dischargeability is excellent even in a case where the chips travel toward the front end 3a. That is, in a case where the connecting surface 13 is open to the first side surface 21a and the second side surface 21b, the insert 1 is not easily limited by the structure of the workpiece and has excellent versatility.

As in the non-limiting example illustrated in FIG. 10, a width W1 of the rising surface 11 may increase with increasing distance from the first side 17 and with increasing distance from the second side 19. When the chips flow toward the rear end 3b, as the chips approach the rear end 3b, that is, as the chips move away from the first side 17 and approach the second side 19, variations in the flow direction of the chips flow tend to increase. Here, in a case where the width W1 of the rising surface 11 is configured as described above, the flow of chips can be stably controlled even when the flow direction of the chips varies. Since the width W1 of the entire rising surface 11 is not large, the insert 1 can be reduced in size.

As in the non-limiting example illustrated in FIG. 6, a width W2 of the connecting surface 13 may be constant from the first side 17 toward the second side 19. The chips curl more easily as a result of the chips coming into contact with the connecting surface 13 having the recessed curved surface shape. In a case where the width W2 of the connecting surface 13 changes with increasing distance from the first side 17 and with increasing proximity to the second side 19, the chips tend to curl into a truncated cone shape on the whole. Thus, the chips tend to form a large lump. On the other hand, in a case where the width W2 of the connecting surface 13 is constant as described above, the chips tend to have a long thin shape, such as a spiral shape, on the whole. Thus, chip dischargeability is excellent.

As in the non-limiting example illustrated in FIG. 11, in the first cross section, the width W2 of the connecting surface 13 may be larger than the width W1 of the rising surface 11. In such a case, since space for the connecting surface 13 is easily secured, chips are easily curled in a stable manner, chip clogging is less likely to occur, and chip dischargeability is excellent.

As described above, the upper surface 9 and the rising surface 11 may each be flat. In a case where the upper surface 9 is flat, a contact area of the chips on the upper surface 9 and the rising surface 11 can be reduced when the chips pass over the upper surface 9, the connecting surface 13, and the rising surface 11 while curling. Thus, the upper surface 9 and the rising surface 11 are not easily worn, and the durability of the insert 1 is high.

In the first cross section, the connecting surface 13 may have an arc shape, and a radius of curvature R1 of the connecting surface 13 may be larger than the width W1 of the rising surface 11. In such a case, the chips are easily curled in a gentle manner, chip clogging is less likely to occur, and chip dischargeability is excellent.

In a case where the connecting surface 13 in the first cross section has the arc shape, the radius of curvature R1 of the connecting surface 13 may be constant from the first side 17 toward the second side 19. In such a case, the chips tend to have a long thin shape, such as a spiral shape, rather than a truncated cone shape on the whole. Thus, chip dischargeability is excellent.

As in the non-limiting example illustrated in FIG. 11, in the first cross section, the connecting surface 13 may have an elliptical arc shape, and the maximum value of the radius of curvature R1 of the connecting surface 13 may be larger than the width W1 of the rising surface 11. In particular, in the non-limiting example illustrated in FIG. 11, the connecting surface 13 is vertically long in the up-down direction, that is, has an elliptical arc shape whose major axis is in the up-down direction. In such a case, the travel of the chips from the connecting surface 13 to the rising surface 11 becomes smooth, and thus chip clogging is less likely to occur, and chip dischargeability is excellent.

In the present disclosure, “constant” does not strictly have to be the same value. This is a concept that allows a degree of variation that is inevitable in manufacturing. Specifically, if the minimum value is 95% or more of the maximum value, it may be evaluated as being constant. For example, the fact that the width W2 of the connecting surface 13 is constant from the first side 17 toward the second side 19 means that the minimum value of the width W2 of the connecting surface 13 may be 95% to 100% of the maximum value of the width W2 of the connecting surface 13.

Examples of a material of the insert 1 may include cemented carbide alloy and cermet. The composition of the cemented carbide alloy may include WC—Co, WC—TiC—Co, and WC—TiC—TaC—Co, for example. Here, WC, TiC and TaC may be hard particles, and Co may be a binder phase.

The cermet may be a sintered composite material in which metal is combined with a ceramic component. Examples of the cermet may include titanium compounds in which one of titanium carbide (TiC) and titanium nitride (TiN) is a main component. However, the material of the insert 1 is not limited to the composition described above.

A surface of the insert 1 may be coated with a coating film using a chemical vapor deposition (CVD) method or a physical vapor deposition (PVD) method. Examples of the composition of the coating film may include titanium carbide (TiC), titanium nitride (TiN), titanium carbonitride (TiCN), and alumina (Al₂O₃).

### Cutting Tool

A cutting tool 101 according to one non-limiting aspect of the present disclosure will be described in detail with reference to the drawings.

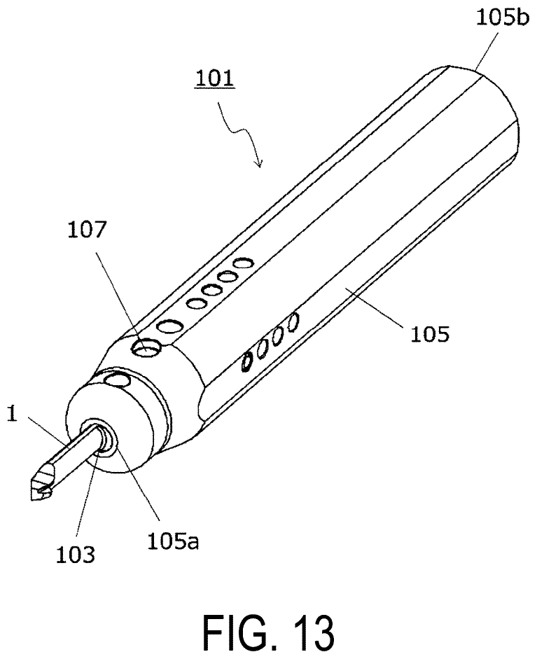

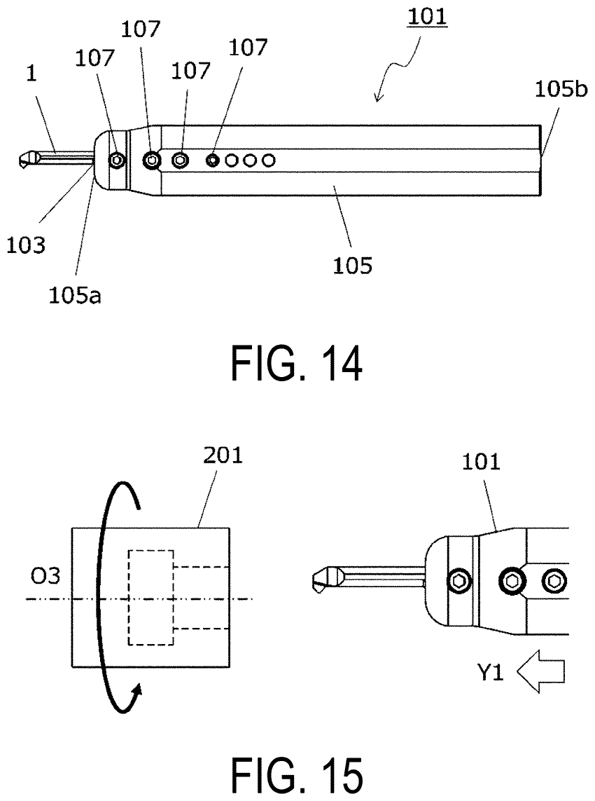

As in a non-limiting example illustrated in FIGS. 13 and 14, the cutting tool 101 may have a rod-shaped holder 105 that extends from a first end 105a toward a second end 105b. Further, the holder 105 has a pocket 103 (insert pocket) located on the side of the first end 105a. The cutting tool 101 may be provided with the above-described insert 1 located in the pocket 103. In the cutting tool 101, the insert 1 may be mounted such that at least part of the cutting edge 7 protrudes from the first end 105a of the holder 105.

The holder 105 may have a rod shape that extends in a long and thin manner. The one pocket 103 may be provided on the side of the first end 105a of the holder 105. The pocket 103 is a portion in which the insert 1 is mounted, and may be open to an end surface on the side of the first end 105a of the holder 105.

As in the non-limiting example illustrated in FIG. 13, the insert 1 may be fixed to the holder 105 by a screw 107. For example, a screw hole may be provided in the holder 105, and the insert 1 may be secured in the pocket 103 by inserting the screw 107 into the screw hole and pressing the screw 107 against the insert 1.

Steel, cast iron, or the like may be used as a material of the holder 105. In particular, in a case where steel is used among these materials, the toughness of the holder 105 is high.

### Method for Manufacturing Machined Product

A method for manufacturing a machined product according to one non-limiting aspect of the present disclosure will be described with reference to the drawings.

A machined product 203 is manufactured by machining a workpiece 201. The method for manufacturing the machined product 203 in the embodiment has the following steps: That is, the present embodiment has:
(1) rotating the workpiece 201,
(2) bringing the cutting tool 101 represented in the above-described embodiment into contact with the workpiece 201 that is rotating, and
(3) separating the cutting tool 101 from the workpiece 201.

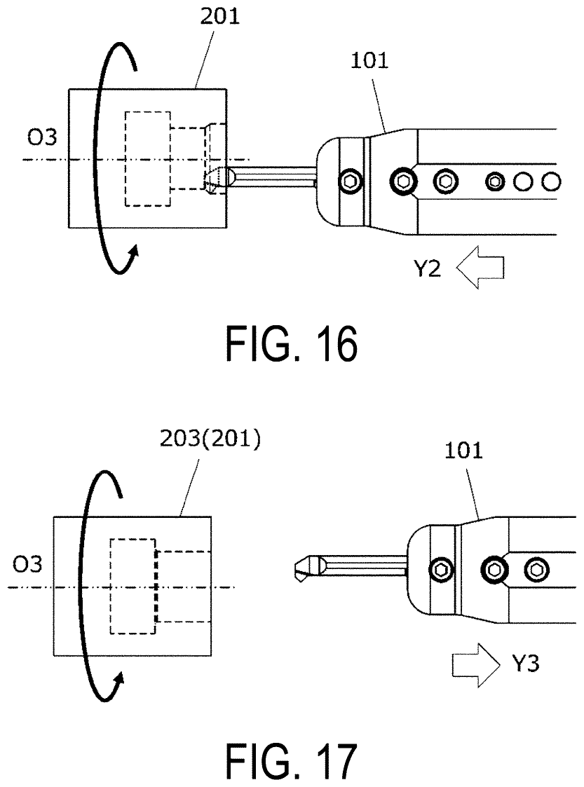

More specifically, first, as in a non-limiting example illustrated in FIG. 15, the workpiece 201 is rotated about an axis O3, and the cutting tool 101 is relatively brought close to the workpiece 201. Subsequently, as in a non-limiting example illustrated in FIG. 16, the workpiece 201 may be cut by bringing at least a part of the cutting edge 7 of the cutting tool 101 into contact with the workpiece 201. Then, as in a non-limiting example illustrated in FIG. 17, the cutting tool 101 may be relatively moved away from the workpiece 201.

As in the non-limiting example illustrated in FIG. 15, the cutting tool 101 may be brought close to the workpiece 201 by moving the cutting tool 101 in a direction Y1 in a state in which the axis O3 is fixed and the workpiece 201 is rotated.

As in the non-limiting example illustrated in FIG. 16, the workpiece 201 may be cut by moving the cutting tool 101 in a direction Y2 in a state in which at least a part of a portion of the insert 1 used as the cutting edge 7 is in contact with the workpiece 201 that is being rotated.

As in the non-limiting example illustrated in FIG. 17, the cutting tool 101 may be moved away from the workpiece 201 by moving the cutting tool 101 in a direction Y3 in a state in which the workpiece 201 is rotated.

By moving the cutting tool 101 at each step, the cutting tool 101 is brought into contact with the workpiece 201 or the cutting tool 101 is separated from the workpiece 201. However, it goes without saying that the mode is not limited to such a mode.

For example, at step (1), the workpiece 201 may be brought close to the cutting tool 101. At step (3), the workpiece 201 may be moved away from the cutting tool 101. In a case where the machining is to be continued, a step of maintaining the rotating state of the workpiece 201 and bringing at least a part of the cutting edge 7 of the insert 1 into contact with different locations of the workpiece 201 may be repeated.

Representative examples of the material of the workpiece 201 may include hardened steel, carbon steel, alloy steel, stainless steel, cast iron, and non-ferrous metals.

### REFERENCE SIGNS

1 Cutting insert (insert)
3 First portion
3a Front end
3b Rear end
5 Second portion
5a Upper end surface
7 Cutting edge
9 Upper surface
11 Rising surface
13 Connecting surface
15 First corner
17 First side
19 Second side
21 Side surface
21a First side surface
21b Second side surface
21c Corner side surface
101 Cutting tool
103 Pocket
105 Holder
107 Screw
201 Workpiece
203 Machined product
O1 Central axis
O2 Virtual straight line
L1 Virtual extended line (of upper surface)
L2 virtual extended line (of rising surface)
θ Angle of intersection of virtual extended lines
φ1 Inclination angle of connecting surface in top view
φ2 Inclination angle of upper surface
W1 Width of rising surface
W2 Width of connecting surface
R1 Radius of curvature

1. A cutting insert comprising:
a first portion having a rod shape and extending along a central axis from a front end toward a rear end; and
a second portion protruding from the front end in a direction orthogonal to the central axis, wherein
the second portion has a triangular shape in a front view, the second portion comprising
an upper surface comprising a first corner protruding from the first portion, a first side extending from the first corner toward the first portion, and a second side extending from the first corner toward the first portion, the second side being located closer to the rear end than the first side,
a cutting edge located on at least a part of the first corner, the first side, and the second side,
a rising surface located closer to the first portion than the upper surface and being inclined upward with increasing distance from the upper surface,
an upper end surface located closer to the first portion than the rising surface, and
a connecting surface having a recessed curved surface shape, the connecting surface being located between the upper surface and the rising surface, and being connected to the upper surface and the rising surface, and
in a cross section orthogonal to the upper end surface and comprising a bisecting line of the first corner, a virtual extended line of the upper surface and a virtual extended line of the rising surface intersect each other at an acute angle.

2. The cutting insert according to claim 1, wherein
a width of the rising surface increases with increasing distance from the first side and with increasing proximity to the second side.

3. The cutting insert according to claim 1, wherein
the upper surface and the rising surface are each flat.

4. The cutting insert according to claim 3, wherein
in the cross section, the connecting surface has an elliptical arc shape, and
a maximum value of a radius of curvature of the connecting surface is larger than the width of the rising surface.

5. A cutting tool comprising:
a holder having a rod shape extending from a first end to a second end, and comprising a pocket located at the first end; and
the cutting insert according to claim 1, the cutting insert being located in the pocket.

6. A method for manufacturing a machined product, the method comprising:
rotating a workpiece;
bringing the cutting tool according to claim 5 into contact with the workpiece that is rotating; and
separating the cutting tool from the workpiece.
